(19) United States
(12) Patent Application Publication
(10) Pub. No.: US 2006/0165947 A1
(43) Pub. Date: Jul. 27, 2006

(54) Reaction-injection-molded, thermal-insulating composite article and methods of making and using the same

(76) Inventor: Warren H. Kellogg, Victor, NY (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/335,531

(22) Filed: Jan. 20, 2006

Related U.S. Application Data
(60) Provisional application No. 60/646,503, filed on Jan. 25, 2005.

(51) Int. Cl. B32B 3/00

(52) U.S. Cl. 428/71

(57) ABSTRACT

Reaction-injection-molded, thermal-insulating composite articles, methods of making reaction-injection-molded, thermal-insulating composite articles, and methods of insulating a space with one or more reaction-injection-molded articles are provided. The reaction-injection-molded, thermal-insulating composite article is comprised of a reaction-injection-molded low-density thermal-insulating resin core substantially encapsulated by a reaction-injection-molded rigid resin outer shell.

### CROSS-REFERENCE TO PRIORITY/PROVISIONAL APPLICATIONS

This application claims priority under 35 U.S.C. § 119 of U.S. Provisional Application Ser. No. 60/646,503, filed Jan. 25, 2005, hereby expressly incorporated by reference in its entirety and assigned to the assignee hereof.

### BACKGROUND

A variety of thermal-insulating articles have been suggested. However, such articles are not optimal for all thermal-insulating applications.

In many applications such as insulation of cooling and/or heating units such as, for example, air conditioning and refrigeration devices, insulation is provided by articles comprised of a metal support and a coating of a thermal-insulating material, such as, for example, a resin foam insulating material, thereon. Because the coating of insulating material on such articles is exposed, the insulating material is unprotected from contact with dirt and/or moisture, which may be generated during operation of an insulated cooling or heating unit. As a result, the exposed insulating material can become soiled and/or unsightly. In addition, the exposed insulating material may be eaten by rodents or other pests. This may exacerbate existing pest problems while at the same time diminish the insulating function of the article. These articles may also lack sufficient structural rigidity, making them unsuitable for many applications. Such metal-supported articles are also relatively heavy, and costly to manufacture, install and maintain.

### SUMMARY

Reaction-injection-molded, thermal-insulating composite articles, methods of making reaction-injection-molded, thermal-insulating composite articles and methods of using reaction-injection-molded thermal-insulating composite articles are provided.

In an exemplary embodiment, a reaction-injection-molded, thermal-insulating composite article comprises a reaction-injection-molded low-density thermal-insulating resin core; and a reaction-injection-molded rigid resin shell, which substantially encapsulates the low-density thermal-insulating resin core.

In an exemplary embodiment, the low-density thermal-insulating resin core is comprised of a resin foam. In exemplary embodiments, the resin foam is a polyurethane foam such as, for example, a polyurethane foam obtained from a two-component polyurethane system. Suitable foams are sold under the trade name Stepanfoam® by the Stepanfoam Company of Northfield, Ill. Additionally, in exemplary embodiments, the rigid outer shell is comprised of a rigid urethane such as, for example, a urethane sold under the product number XRS-8717 by ICI Polyurethanes Group, of Sterling Heights, Mich. Further, in exemplary embodiments, the molded article provides an R value (thermal resistivity in units of ft.²h° F./Btu) of at least about 5, more preferably at least about 7, more preferably at least about 9, and most preferably at least about 10. In further exemplary embodiments, the article may also provide flame-resistance, such as, for example, a flame rating of at least about UL 94.

In an exemplary embodiment, a method of making a reaction-injection-molded, thermal-insulating composite article comprises casting the composite article in a reaction-injection-molding process by casting a low-density thermal-insulating resin core in a first mold, placing the first mold in a second mold, and casting in the second mold a rigid resin shell so that when molding is complete the rigid resin shell substantially encapsulates the low-density thermal-insulating resin core.

In exemplary embodiments, the first mold is placed or suspended within the second mold using pins, or other equivalent suspension means, including, but not limited to, nails, screws, clips, fasteners, hangers, tacks, pegs, combinations thereof and the like. The first mold can also be placed and/or suspended in the second mold using an adhesive or a support means such as, for example, nails, screws, clips, fasteners, hangers, tacks, pegs, blocks, combinations thereof and the like.

In exemplary embodiments, the low-density thermal-insulating resin core can be made of a resin foam such as, for example, a polyurethane foam obtained from a two-component polyurethane system. Suitable foams are provided under the trade name Stepanfoam® by the Stepanfoam Company of Northfield, Ill. Also, in exemplary embodiments, the rigid resin shell can be a rigid urethane such as, for example, a urethane sold under the product number XRS-8717 by ICI Polyurethanes Group, of Sterling Heights, Mich. In yet another exemplary embodiment, the process can include providing an amount of the low-density thermal-insulating resin and an amount of the rigid resin effective to enable the molded article to exhibit a thermal resistively (R value in ft.²h° F./Btu) of at least about 5, preferably at least about 7, more preferably at least about 9, and most preferably at least about 10. In other exemplary embodiments, the amounts of low-density thermal-insulating resin and rigid resin are effective to enable the molded article to exhibit a flame rating of at least about UL 94.

In another exemplary embodiment, a method of making a reaction-injection-molded, thermal-insulating composite article comprises casting the article in a reaction injection molding process by casting an outer shell of a rigid resin material; casting a low-density thermal-insulating resin core on an interior surface of the outer shell; and casting an inner rigid resin shell on a side of the core opposite the interior surface of the outer shell so that the low-density thermal-insulating resin core is substantially encapsulated between the inner shell and the outer shell. In exemplary embodiments, the low-density thermal-insulating resin core can be a resin foam such as, for example, a polyurethane foam obtained from a two-component polyurethane system. Suitable foams are provided under the trade name Stepanfoam® by the Stepanfoam Company of Northfield, Ill. Also, in exemplary embodiments, the rigid resin material used to form the inner and outer shells, which substantially encapsulate the thermal-insulating resin core, can be a rigid urethane such as, for example, a urethane provided under the product number XRS-8717 by ICI Polyurethanes Group, of Sterling Heights, Mich. In other exemplary embodiments, the resulting molded article can have amounts of the low-density thermal-insulating resin and the rigid resin effective to enable the article to exhibit a thermal resistance (R value in ft.²h° F./Btu) of at least about 5, preferably at least about 7, more preferably at least about 9, and most preferably at least about 10. In other exemplary embodiments, the amounts of low-density thermal-insulating resin and rigid resin are effective to enable resulting molded article to exhibit a flame rating of at least about UL 94.

In another exemplary embodiment, a method of thermally-insulating a space comprises substantially enclosing the space with one or more reaction-injection-molded, thermal-insulating composite articles, the articles comprising a reaction-injection-molded low-density thermal-insulating resin core substantially encapsulated in a reaction-injection-molded rigid resin outer shell. In exemplary embodiments, the low-density thermal-insulating resin is a foam resin such as, for example, a polyurethane foam obtained from a two-component polyurethane system. Suitable foams are provided under the trade name Stepanfoam® by the Stepanfoam Company of Northfield, Ill. In exemplary embodiments, the rigid resin outer shell is comprised of a rigid urethane such as, for example, a urethane provided under the product number XRS-8717 by ICI Polyurethanes Group, of Sterling Heights, Mich. In exemplary embodiments, the amounts of low-density thermal-insulating resin and rigid resin are effective to enable the molded article to exhibit a thermal resistivity (R value ft.²h° F./Btu) of at least about 5, preferably at least about 7, more preferably at least about 9, and most preferably at least about 10. In another exemplary embodiment, the amounts of low-density thermal-insulating resin and rigid resin are effective to enable the molded article to exhibit a flame rating of at least about UL 94. In another exemplary embodiment, the substantially enclosed space comprises a heating and/or cooling unit or a component of such a unit.

### BRIEF DESCRIPTION OF THE DRAWINGS

FIG. 1A is a schematic of an exemplary embodiment of a reaction-injection-molded, thermal-insulating composite article.

FIG. 1 B is a schematic of an exemplary embodiment of a reaction-injection-molded, thermal-insulating composite article insulating a component of a heating and/or cooling unit.

FIG. 2 is a schematic of a molding arrangement used in an exemplary reaction-injection-molding process for making a thermal-insulating composite article.

FIG. 3A is a schematic of a step used in another exemplary reaction-injection-molding process for making a thermal-insulating composite article.

FIG. 3B is a schematic of another step used in an exemplary reaction-injection-molding process for making a thermal-insulating composite article.

FIG. 3C is a schematic of yet another step used in an exemplary reaction-injection-molding process for making a thermal-insulating composite article.

### DETAILED DESCRIPTION

Reaction-injection-molded, thermal-insulating composite articles, and methods of making and using the same are provided.

The term “low-density thermal-insulating resin” refers to any resin that can be used in a reaction-injection-molding process, has a relatively low-density and can provide thermal-insulating properties. In exemplary embodiments, “low density” can refer to materials having a density of about 0.25 lb/ft³ to about 3 lb/ft³, preferably about 0.5 lb/ft³ to about 2.5 lb/ft³, more preferably about 1 lb/ft³ to about 2.25 lb/ft³, and most preferably about 2 lb/ft³. Suitable materials include resins used in thermal-insulating applications including, for example, heating and/or cooling applications, air conditioning applications, refrigeration applications, combinations thereof and the like. Suitable low-density thermal-insulating resins can include, for example, resin foam materials such as foams obtained by a two-component polyurethane system. Suitable polyurethane foams are provided for example, by the Stepanfoam Company under the tradename Stepanfoam®. Other suitable low density resins are sold by the Urethane Technology Corporation.

One suitable foam is obtained by a two-component system, wherein one of the components, a polyol component, has a hand mix reactivity at about 90°F. (about 32.3° C.) sufficient to provide a cream time of about 1 second to about 20 seconds, preferably about 5 seconds to about 18 seconds, more preferably about 7 seconds to about 15 seconds, and most preferably about 14 seconds. The polyol component may also exhibit a string time at about 90° F. of about 1 second to about 75 seconds, preferably about 5 seconds to about 65 seconds, more preferably about 10 seconds to about 60 seconds, and most preferably about 55 seconds. The polyol component can also exhibit a cup density (#10 cup, pcf) at about 90° F. of about 0.1 to about 5, preferably about 0.5 to about 3, more preferably about 1 to about 2, and most preferably about 1.5.

The polyol component can also exhibit a certain molded and/or core density (determined under ASTM D-1622). Descriptions of the American Society for Testing and Materials' (ASTM) standards and testing can be found in the publications of ASTM International as well as on the ASTM website (see, e.g., www.astm.org.), the entire disclosures of which are hereby incorporated by reference. For example the polyol component can exhibit a molded density (overall, pcf of about 0.5 to about 5, preferably about 1 to about 3, more preferably about 1.5 to about 2.5, and most preferably about 2.0. A suitable polyol component can also exhibit a core density (pcf) of about 0.5 to about 5, preferably about 1 to about 3, more preferably about 1.5 to about 2.5, and most preferably about 1.90.

The polyol component can also exhibit a compressive strength at about 10% deflection (ASTM D-1621) which enables it to provide a parallel strength (in psi) of about 5 to about 30, preferably about 10 to about 25, and most preferably about 20, and a perpendicular strength (in psi) of about 5 to about 35, preferably about 10 to about 30, and most preferably about 25.

The polyol component can also exhibit a tensile strength (ASTM D-1623, psi) of up to about 40, preferably about 5 to about 35, more preferably about 10 to about 30, and most preferably about 28.5.

The polyol component can also exhibit a tumbling friability (ASTM C-421, % loss) of about 1 to about 10, preferably about 1.5 to about 8, more preferably about 2 to about 5, more preferably about 3 to about 4, and most preferably about 3.22.

The polyol component can also exhibit the following dimensional stablity characteristics (ASTM D-2126, % volume change):

| | | | % Volume |
|---|---|---|---|
| | % Volume | % Volume | Change at |
| | Change at | Change at | about 158° F. |
| | about −20° F. | about 158° F. | (about 70° C.) |
| Days | (about −29° C.) | (about 70° C.) | about 100% R.H. |
| About 7 days | About 0.01 to | About −0.01 to | About 0.10 to |
| | about 0.05 | about −0.10 | about 0.20 |
| | (preferably | (preferably | (preferably |
| | about 0.04) | about −0.09) | about 0.17) |
| About 14 days | About 0.1 to | About −0.01 to | About 0.1 to |
| | about 0.5 | about −0.10 | about 0.3 |
| | (preferably | (preferably | (preferably |
| | about 0.2) | about −0.06) | about 0.22) |
| About 28 days | About 0.01 to | About −0.01 to | About −0.10 to |
| | about 0.10 | about −0.10 | about −2.00 |
| | (preferably | (preferably | (preferably |
| | about 0.05) | about −0.89) | about −1.02) |

Suitable resin foams obtained by using a polyol component exhibiting one or more of the above-specified properties can be used in a two-component polyurethane system to produce an about 100% water-blown rigid polyurethane foam. Such a system need not, and preferably does not, contain HCFC or HFC blowing agents. A suitable second component, which can be combined with a polyol component exhibiting one or more of the above properties, can be a polymeric methane diisocyante (MDI), such as, for example, Mondur® 489, provided by the Bayer® Corporation.

In an exemplary two-component polyurethane system, the polyol component can exhibit a viscosity at about 77° F. (about 25° C., cps) of about 200 to about 1,000, preferably about 300 to about 900, more preferably about 400 to about 800, and most preferably about 700. The second component (a polymeric methyl diisocyante or similarly-effective component) can also exhibit a viscosity at about 77° F. (about 25° C., cps) of about 200 to about 1,000, preferably about 300 to about 900, more preferably about 400 to about 800, and most preferably about 700.

In a suitable two-component polyurethane system, the polyol component can exhibit a specific gravity at about 77° F. (about 25° C.) of about 0.5 to about 3, preferably about 1 to about 2, and most preferably about 1.24. The second component (a polymeric methyl diisocyante or similarily-effective component) can also exhibit a specific gravity at about 77° F. (about 25° C.) of about 0.5 to about 3, preferably about 1 to about 2, and most preferably about 1.17.

In a suitble two-component system, the mixing ratio, in % by weight, of the polyol component is about 50% to about 70%, preferably about 55% to about 65%, and most preferably about 65.5%. The mixing ratio, in % by weight, of the second component (a polymeric methyl diisocyante or similarily-effective component) is about 50% to about 30%, preferably about 45% to about 35%, and most preferably about 37.5%.

The term “rigid resin” refers to any relatively structurally rigid resin material that can be used in a reaction-injection-molding process to mold a shell that substantially encapsulates a reaction-injection-molded low-density thermal-insulating resin core. Suitable rigid resin materials can have a density of 1 lb/ft³ to about 25 lb/ft³, preferably about 2 lb/ft³ to about 20 lb/ft³, more preferably about 4 lb/ft³ to about 18 lb/ft³, and most preferably about 8 lb/ft³ to about 16 lb/ft³. In exemplary embodiments, the rigid resin can be a rigid urethane such as, for example, a urethane provided under the product number XRS-8717 by ICI Polyurethanes Group of Sterling Heights, Mich. Other suitable rigid resin materials are sold by Urethane Technology Corp., Bayer® Corporation, and BASF® Corporation.

A suitable rigid resin can be a two-component structural foam such as, for example, a urethane foam. A suitable urethane foam or equivalent thereof can exhibit a density (in pcf) of about 10 to about 30, preferably about 15 to about 25, and most preferably about 18 to about 20. A suitable urethane foam or equivalent thereof can also exhibit a hardness (Shore A) of between about 60 to about 100, preferably about 70 to about 90, more preferably about 75 to about 85, and most preferably about 80 to about 85. Suitable urethane foams or equivalents thereof can also also exhibit an elongation at break (%) of about 1 to about 10, preferably about 2 to about 8, more preferably about 2.5 to about 7, and most preferably about 3 to about 5. Suitable urethane foams and equivalents thereof can exhibit a compression strength (in psi, 10% Deformation) of about 500 to about 1,000, preferably about 600 to about 900, more preferably about 650 to about 800, and most preferably about 700 to about 750. A suitable urethane foam or equivalent thereof can also exhibit a heat distribution temperature (at about 66 psi, in ° C.) of about 30 to about 70, preferably about 40 to about 65, more preferably about 50 to about 60, and most preferably about 56 to about 58. A suitable urethane foam or equivalent thereof can also also exhibit a flexural modulus (in psi) of about 5,000 to about 50,000, preferably about 10,000 to about 40,000, more preferably about 15,000 to about 30,000, and most preferably about 20,000 to about 25,000. (The properties described in the above paragraph are determined using ASTM methods at about 73° F.)

As those of skill in the art will appreciate, based on the detailed description and illustrative examples provided herein, there are a number of known alternative materials, which can be used in exemplary articles and/or methods. Numerous technical references describing such alternatives, and methods applicable to the preparation and/or testing of such alternatives are available. For example, references describing various plastic polymers, additives, composites and related systems and processes include the following: Plastics Encyclopedia, by Dominick Rosato, 1993; Physics Of Plastics: Processing, Properties and Materials Engineering, by Jim Batchelor et al. 1992; Reaction of Polymers, by Wilson Gum et al., 1992; Plastics for Engineers: Materials, Properties and Applications, by Hans Dominghaus, 1993; Reactive Polymer Blending, by Warren E. Baker et al., 2001; Plastics Additives Handbooks by Hans Zweifel, 2001; Guide to Short Fiber Reinforced Plastics, by Roger Fat Jones, 1998; Coloring of Plastics: Fundamentals, Colorants, Preparations, by Albrecht Muller, 2003; Plastics Flammability Handbook: Principles, Testing, Regulation and Approval, by Jurgen H. Troitzsch, 2004; Discovering Polyurethanes, Konrad Uhlig, 1999; Polyurethane Handbook: Chemistry, Raw Materials, Processing, Applications Properties, by Gunter Qertel, 1994; Introduction to Industrial Polymers by IIenri Ulrich, 1993; Performance of Plastics by Witold Brostow, 2000; Rheology of Polymeric Systems, by Pierre J. Carreau et al., 1997; Plastics: How Structure Determines Properties, by Geza Gruenwald, 1993; Polymeric Material and Processing: Plastics, Elastomers and Composites by Jean-Michel Charrier et al., 1999; Composite Materials Technology: Processes and Properties, by P.K. Mallick, 1990; Compression Molding, by Bruce Davis et al, 2003; Plastics Failure Guide: Cause and Preventions by Meyer Ezrin, 1996; Failure of Plastics, by Witold Brostow, 1986; Wear in Plastics Processing: How to Understand, Protect, and Avoid, by Gunter Menning, 1995; Polymer Interfaces: Structure and Strength, by Richard P. Wool, 1995; Polymer Engineering Principles, by Richard C, Progelhof et al., 1993; Polymer Mixing, by Chris Rauendaal, 1998; Polymeric Compatibilizers: Uses and Benefits in Polymer Blends, by Sudhin Datta et al., 1996; Materials Science of Polymers for Engineers, by Georg Menges, 2003; Reaction Injection Molding, by Christopher W. Makosko, 1988; Successful Injection Molding, by John Beaumont et al., 2002; Injection Molding Handbook, by Paul Gramann, 2001; Mold Engineering, by Herbert Rees, 2002; Mold Making Handbook for the Plastics Engineer, by Gunter Menning, 1998; Total Quality Process Control for Injection Molding, by Joseph M. Gordon, Jr., 1992; Adhesion and Adhesives Technology, by Alphonsus V. Pocius, 2002; Performance Enhancement in Coatings, by Edward W. Orr, 1998; Plastics and Coatings, by Rose Ryntz, 2001; Advanced Protective Coatings for Manufacturing and Engineering, by Wit Grzesik, 2003; and the like. The entire disclosures of these references are hereby incorporated by reference.

The term “substantially encapsulated” refers to the rigid resin outer shell's encapsulation of the low-density thermal-insulating resin core. As used herein, the term “substantially encapsulated” is intended to mean that the rigid resin shell surrounds the low-density thermal-insulating resin core so that the core is at least about 85% encapsulated, preferably at least about 90% encapsulated, more preferably at least about 95% encapsulated, more preferably at least about 97% encapsulated, even more preferably at least about 99% encapsulated, and most preferably at least about 100% encapsulated. In exemplary embodiments, the substantially encapsulated low-density thermal-insulating resin core is encapsulated to an extent that the resin core is substantially protected from the surrounding environment including, for example, dirt, light, ambient air, moisture or damage such as, for example, damage commonly experienced through normal wear or as a result of rodents and/or pests that might otherwise feed upon the resin core material.

The term “substantially enclosed” refers to the arrangement of one or more reaction-injection-molded composite articles, as described herein, to thermally insluate a space. As used herein, the term is intended to mean that one or more composite articles are arranged relative to a space so that the space is thermally insulated to some degree more than it would have been in the absence of the one or more of the composite articles. In exemplary embodiments, one or more composite articles can be arranged on one or more sides of the space being insulated. In exemplary embodiments, it may be useful to arrange one or more articles on each side of the space being insulated. Often, the space to be insulated includes a heating an/or cooling unit or a component of such a unit. For example, it may be desirbale to insulate a component of such a unit that generates heat during operation.

In exemplary embodiments, the resulting thermal-insulating composite molded article is lighter in weight than comparably-sized metal-reinforced thermal-insulating materials, and provides a thermal resistivity (R value, ft.²h° F. /Btu) of at least about 5, preferably at least about 7, more preferably at least about 8, even more preferably at least about 9, and most preferably at least about 10. Additionally, in exemplary embodiments, the composite molded article exhibits a flame rating of at least about UL 94.

The term “reaction injection molding” as used herein refers to a process of molding an article using liquid reactants. The liquid reactants (often an isocyanate and a polyol) are pumped into a mix head where they are combined under pressure. The mixture, when injected (shot) into a mold, fills the mold cavity under pressure. An exothermic chemical reaction supplies energy to polymerize the reactants into a solid mass. Reaction injection molding machines, which may be used, to make thermal-insulating composite molded articles, as described herein, are provided by manufactures, including, but not limited to, Gusmer-Admiral Inc., Krauss-Maffei, Linden Industries, Cannon U.S.A., and Rimnetics, Inc. Additionally, exemplary reaction injection molding processes are described, for example, in U.S. Pat. Nos. 4,218,543; 4,582,879; 4,534,003; and 5,004,351, the entire disclosures of which are hereby incorporated by reference.

Reaction-injection-molded, composite articles, as described herein, can be used in a variety of applications. Possible applications include, but are not limited to, heat shields for aircraft, aerospace, defense and power generation applications; inlsulation for fuel tanks; insulation of appliances (e.g., household appliances such as refrigerators, dishwashers, ranges, microwave ovens, laundry washers and dryers, freezers, air conditioners, dehumidifiers, portable heaters, combinations thereof and the like); refrigeration applications (e.g., cold storage buildings, champagne buckets, ice buckets, beverage coolers, walk-in freezers, refrigerated railroad freight cars or trailers, combinations thereof and the like); swimming pool covers, hot tub covers; swimming pool or hot tub liners; cooling towers; insulated structural panels for residential or commercial construction; insulated shipping containers; housings for electrical components; combinations thereof and the like.

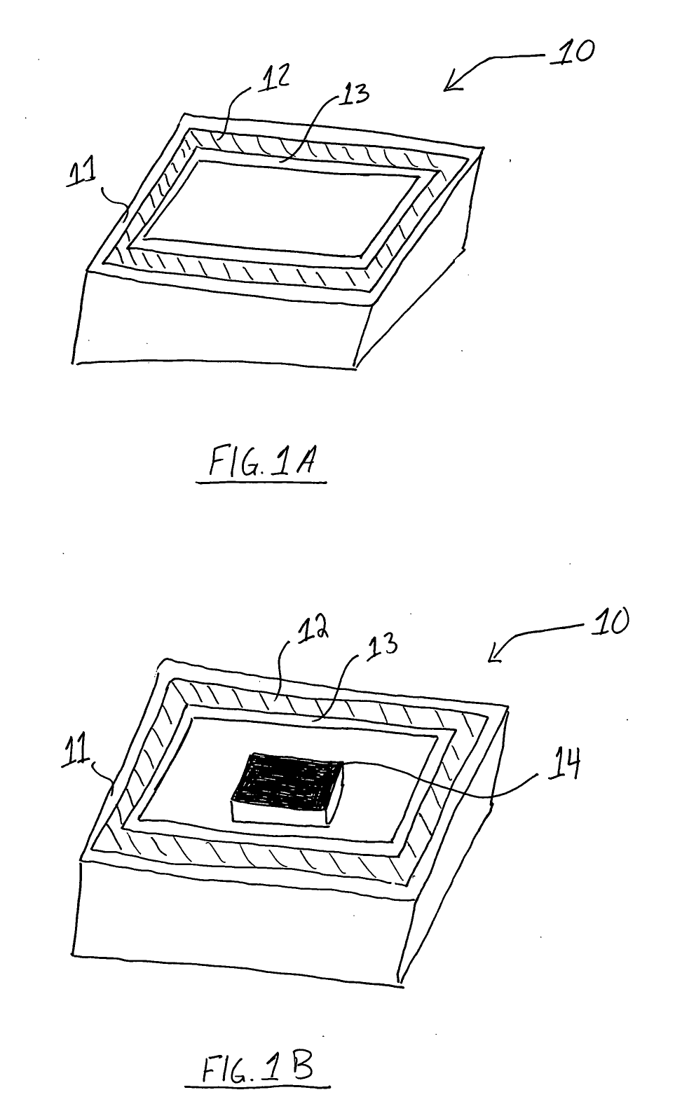

An exemplary reaction-injection-molded, thermal-insulating composite article 10 is depicted in FIG. 1A. Although the article 10 in FIG. 1A is in the shape of a box, the article 10 can be any shape and/or size depending on the intended application. The article 10 comprises an outer shell 11 comprised of a rigid resin such as, for example, a rigid urethane. The article 10 further comprises an inner core 12 comprised of a low-density thermal-insulating resin such as, for example, a resin foam. In exemplary embodiments, the core 12 can be comprised of a low-density polyurethane foam such as, for example, a foam obtained from a two-component polyurethane system. Suitable foams are sold under the tradename Stepanfoam® such as, for example, Stepanfoam® RI19738 by the Stepanfoam Company of Northfield, Ill. The article 10 further comprises an inner shell 13 comprised of a rigid resin such as, for example, a rigid urethane. In exemplary embodiments, the rigid resin outer shell 11 and inner shell 13 can be a rigid urethane such as, for example, a urethane provided under the product name XRS-8717 by ICI Polyurethanes Group of Sterling Heights, Mich.

FIG. 1B is a schematic of an exemplary reaction-injection-molded, thermal-insulating composite article 10, as depicted in FIG. 1A, insulating a heating and/or cooling unit or a component of such a unit 14.

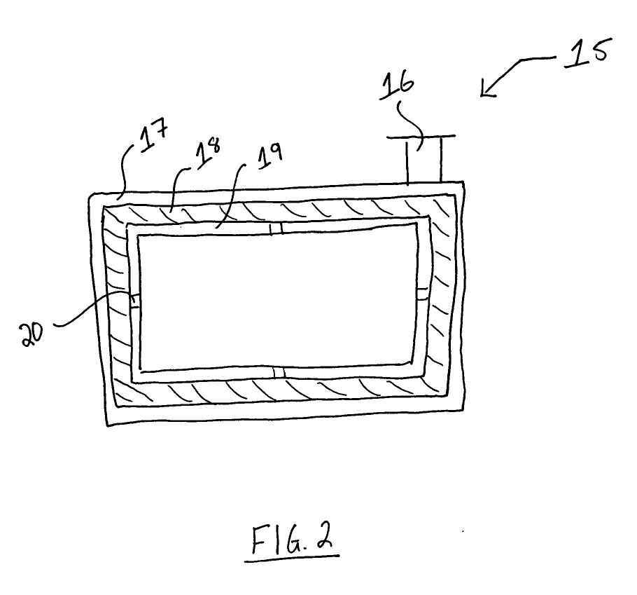

FIG. 2 is a schematic of a molding arrangement 15 used in an exemplary reaction-injection-molding process for making a thermal-insulating composite article. The method comprises casting a low-density thermal-insulating resin core 18 in a first mold. The method further comprises suspending the resin core 18 in a second mold used to cast an outer shell 17 and inner shell 19. The process is conducted using standard reaction injection molding conditions and apparatuses. Before molding, the components are mixed in a reaction injection molding mix head 16. During molding, the low-density thermal-insulating core 18, molded within the first mold, can be suspended in the second mold using pins 20 or equivalent suspension means. When completed, the finished article comprises a low-density thermal-insulating resin core 18 that is substantially encapsulated within the outer shell 17 and inner shell 19.

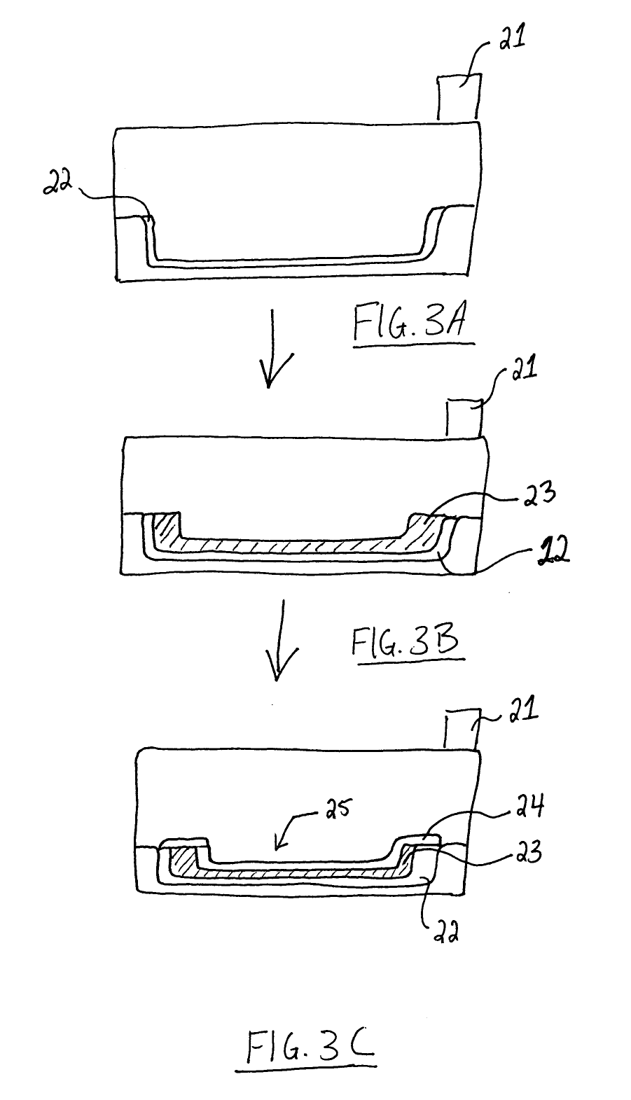

FIGS. 3A, 3B and 3C depict a sequence of another exemplary reaction-injection-molding process for making a thermal-insulating composite article 25. Before molding, the components are combined under pressure in a mix head 21. The process comprises casting a rigid resin outer shell 22. (See FIG. 3A.) The process further comprises casting a low-density thermal-insulating resin core 23 on top of the rigid resin outer shell 22. (See FIG. 3B.) The process further comprises casting an inner rigid resin shell 24 on top of the thermal-insulating core 23 so that the core 23 is substantially encapsulated inside the outer shell 22 and inner shell 24. (See FIG. 3C.)

### EXAMPLES

### Example 1

Processes For Making a Reaction-Injection-Molded, Thermal-Insulating Composite Article:

For the core portion of the article an appropriate volume of Stepanfoamfoam® RI9738 is combined with Mondur® 489 in a two-component polyurethane system to obtain a low-density thermal-insulating polyurethane foam. The system does not contain HCFC or HFC blowing agents. The material is classified as a UL 94 HF-1 product in accordance with UL 94.

In the two-component polyurethane system, the components exhibit the following properties:

| | | Component B |
|---|---|---|
| | Component A | Stepanfoam ® |
| Component | Mondur ® 489 | RI9739 Polyol |
| Properties | Polymeric MDI | Blend |
| Viscosity at 77° F | 700 | 700 |
| (25° C.), cps | | |
| Specific gravity at | 1.24 | 1.17 |
| 77° F. (25° C.) | | |
| Mixing ratio % by | 62.5 | 37.5 |
| weight | | |

The Stepanfoam® RI9738 component (component B) exhibits the following typical reactivity properties:

Hand mix reactivity at 90° F. (32.3° C.)
Cream time, seconds . . . 14
String time, seconds . . . 55
Cup density # 10 cup pcf . . . 1.50

The Stepanfoam® RI9738 component (Component B) also exhibits the following typical foam properties:

Density ASTM D-1622
Molded overall, pcf . . . 2.0
Core pcf . . . 1.90

Compressive strength, 10% deflection ASTM D-1621
Parallel, psi . . . 20
Perpendicular, psi . . . 25
Shear strength, ASTM C-273, psi . . . 23.3
Tensile strength, ASTM D-1623, psi . . . 28.5
Tumbling friability, ASTM C421, % loss . . . 3.22

Dimensional stability, ASTM D-2126, % volume change:

| | | | At 158° F. |
|---|---|---|---|
| | | | (70° C.)/100% |
| Days | At −20° F. (−29° C.) | At 158° F. (70° C.) | R.H.) |
| 7 days | 0.04 | −0.09 | 0.17 |
| 14 days | 0.2 | −0.06 | 0.22 |
| 28 days | 0.05 | −0.89 | −1.02 |

For the rigid, substantially encapsulating shell an appropriate volume of XRS-8717 urethane from ICI Polyurethanes Groups of Sterling Heights, Mich. is provided. XRS-8717 is a two-component polyurethane structural foam system designed for medium- to high-density (18-40 pcf) moldings requiring good temperature stability.

Typical physical properties of XRS-8717 (determined using ASTM methods at 73° F.) are as follows:

| Property | Units | Results |
|---|---|---|
| Density | pcf | 18-20 |
| Hardness | Shore A | 80-85 |
| Tensile strength | psi | 400-450 |
| Elongation at break | % | 3-5 |
| Compression | psi | 700-750 |
| strength | | (10% deformation) |
| Heat distortion | ° C. | 56-58 |
| temperature (66 psi) | | |
| Flexural modulus | psi | 20,000-25,000 |

During molding, the following chemical composition is used:

| A Component-Isocyanate | |
|---|---|
| RIM8700A | B Component-Polyol XRS 8717 |
| Modified MDI | Polyether polyol blended with |
| | additives. |
| pale brown liquid | pale yellow liquid |
| Specific gravity at | Specific gravity at |
| 77° F. (25°) = 1.24 | 77° F. (25°) = 1.04 |
| Viscosity at 77° F. (25°) = 250 cps | Viscosity at 77° F. (25°) = 1,000 cps |
| flash point ° F. >230 | flash point ° F. >230 |

The following typical processing conditions are used:

A/B weight ratio: 118/110

Component temperatures (A and B): 75-90° F.

Mold temperatures ° F.: 135-150

Density range 0.25 to 0.6 g/cc

Demold time: 4-8 minutes

Part thickness: 1-3 inches

Molding shrinkage:

Approximately .0073 inch/inch (0.73%) for a 1 inch thick part at 20 pcf (.32 g/cc).

The composite article is molded using the above materials in one of two processes.

Process Option 1:

The above-described materials are loaded into a reaction-injection-molding machine. The two-component system used to form the low-density thermal-insulating core (i.e., Component A-Mondur® 489 and Component B-Stepanfoam® RI9738) are loaded into the reaction-injection-molding machine. The components are maintained at a temperature of about 90° F. before shooting them into a mold. A first mold is provided in an appropriate size and configuration for the core of the article to be molded. The components are shot into the mold to form the core section of the article. The duration of the shot is about 2-3 seconds. The temperature of the mold is about 160° F. The mold used to cast the core section of the article is suspended in a second mold, which has a space available for the first mold. The second mold is configured to form a shell that will substantially encapsulate the core. The two-component system used to form the shell (i.e., Component A-isocyanate RIM8700 A and Component B-polyol XRS-8717) are loaded into the reaction-injection-molding machine. Before shooting the materials into the second mold, the materials are maintained at a temperature of about 90° F. The materials are then shot into the second mold in order to form a substantially encapsulating shell. The duration of the shot is about 2-3 seconds. The mold temperature during shooting is about 160° F. The in-mold time for the core and shell is about 5 minutes. After about 5 minutes, the article is demolded. The resulting article is comprised of a rigid urethane shell that substantially encapsulates a low-density thermal-insulating core.

Process Option II:

The above components used to form the core and substantially encapsulating shell are loaded into a reaction-injection-molding machine. In a first step the components used to form the shell are shot into a mold to form an outer portion of the substantially encapsulating shell. The components are maintained at a temperature of about 90° F. before shooting, and the duration of the shot is about 2-3 seconds. During molding, the temperature of the mold is about 160° F. Next, the components used to form the core are shot into the mold. Before shooting, the materials are maintained at about 90° F. The duration of the shot is about 2-3 seconds. During molding the mold temperature is about 160° F. Finally, the components used for the shell are again shot into the mold to form an inner portion of the shell, thereby substantially encapsulating the core between the outer region of the shell and the inner region of the shell. Again, the components used to form the inner region of the shell are maintained at about 90° F. before shooting, and the duration of the shot is about 2-3 seconds. The mold temperature during the shot is about 160° F. The total in-mold time is about 5 minutes. Once molding is complete, the composite molded article is removed from the mold. In its final form, the article is comprised of a rigid urethane shell substantially encapsulating a low-density thermal-insulating resin core region.

While the above articles and methods have been described with reference to specific embodiments, this application is intended to cover those various changes and substitutions that may be made by those of ordinary skill in the art without departing from the spirit and scope of the appended claims including equivalents thereof.

Each patent, patent application, publication and literature article/report cited or indicated herein is hereby expressly incorporated by reference in its entirety.

What is claimed is :

1. A reaction-injection-molded, thermal-insulating composite article, the article comprising a reaction-injection-molded low-density thermal-insulating resin core; and a reaction-injection-molded rigid resin shell, which substantially encapsulates the thermal-insulating resin core.

2. The article of claim 1, wherein the amounts of the low-density thermal-insulating resin and the rigid resin forming the article are effective to enable article to exhibit a thermal resistivity (R value) of at least about 10 ft.²h° F./Btu.

3. The article of claim 1, wherein the core is comprised of a low-density polyurethane foam.

4. The article of claim 1, wherein the shell is comprised of a rigid urethane.

5. The article of claim 1, wherein the amounts of the low-density thermal-insulating resin and the rigid resin forming the article are effective to enable the article to exhibit a flame rating of at least about UL 94.

6. A method of making a reaction-injection-molded, thermal-insulating composite article, the method comprising molding the article in a reaction-injection-molding process by casting in a first mold a low-density thermal-insulating resin core; placing the first mold in a second mold; and casting in the second mold a rigid resin shell so that when molding is complete, the rigid resin shell substantially encapsulates the thermal-insulating resin core.

7. The method of claim 6, further comprising forming the article using amounts of the low-density thermal-insulating resin and the rigid resin effective to enable the article to exhibit a thermal resistivity (R value) of at least about 10 ft.²h° F./Btu.

8. The method of claim 6, further comprising forming the article using amounts of the low-density thermal-insulating resin and the rigid resin effective to enable the article to exhibit a flame rating of at least about UL 94.

9. The method of claim 6, wherein the low-density thermal-insulating resin is a low-density polyurethane foam.

10. The method of claim 6, wherein the rigid resin is a rigid urethane.

11. A method of making a reaction-injection-molded, thermal-insulating composite article, the method comprising molding the article in a reaction-injection-molding process by casting a rigid resin outer shell; casting on an interior surface of the outer shell, a low-density thermal-insulating resin core; and casting on a side of the core opposite the interior surface of the outer shell, a rigid resin inner shell so that when molding is complete, the core is substantially encapsulated between the inner shell and the outer shell.

12. The method of claim 11, further comprising forming the article using amounts of the low-density thermal-insulating resin and the rigid resin effective to enable the article to exhibit a thermal resistivity (R value) of at least about 10 ft.²h° F./Btu.

13. The method of claim 11, further comprising forming the article using amounts of the low-density thermal-insulating resin and the rigid resin effective to enable the article to exhibit a flame rating of at least about UL 94.

14. The method of claim 11, wherein the low-density thermal-insulating resin is a low-density polyurethane foam.

15. The method of claim 11, wherein the rigid resin is a rigid urethane.

16. A method of insulating a space, the method comprising substantially enclosing the space with one or more reaction-injection-molded, thermal-insulating composite articles according to claim 1.

17. The method of claim 16, wherein the substantially enclosed space comprises a component of a heating and/or cooling unit.

18. The method of claim 16, wherein the thermal-insulating resin core is comprised of a low-density polyurethane foam, and the outer shell is comprised of a rigid urethane.

19. The method of claim 16, wherein the composite article exhibits a thermal resistivity of at least about 10 ft.²h° F. /Btu.

20. The method of claim 16, wherein the composite article exhibits a flame rating of at least about UL 94.
